(19) United States
(12) Patent Application Publication
(10) Pub. No.: US 2026/0175369 A1
(43) Pub. Date: Jun. 25, 2026

(54) TOOL

(71) Applicant: Stanley Black & Decker MEA FZE, Dubai (AE)

(72) Inventors: Chao Hung HUANG, Taipei (TW); Chan Yi TUNG, Taipei (TW); Ching Yi TU, Taipei (TW)

(21) Appl. No.: 19/422,553

(22) Filed: Dec. 17, 2025

(30) Foreign Application Priority Data
Dec. 19, 2024 (EP) 24221934.3

(51) Int. Cl. B25B 13/06

(52) U.S. Cl. CPC B25B 13/065

(57) ABSTRACT

A tool for driving a fastener comprises a first fastener corner and a second fastener corner and a first fastener flat surface extending therebetween having a flat surface length. The tool also comprises a socket with a socket cavity having a first tool recess arranged to receive the first fastener corner and a second tool recess arranged to receive the second fastener corner and a first protruding portion between the first tool recess and the second tool recess. The first protruding portion is arranged to engage the first fastener flat surface at a first protrusion engagement position between 34% to 41% of the flat surface length from the first fastener corner and the protrusion height of the first protruding portion is 2.8% of an opening dimension of the socket cavity.

### CROSS-REFERENCE TO RELATED APPLICATIONS

This application claims the benefit and priority of European Patent App. Ser. No. 24221934.3, filed Dec. 19, 2024, the entire disclosure of which is incorporated herein by reference.

### FIELD

The present disclosure relates to a tool. In particular the present disclosure relates to a socket, a nut driver or a wrench.

### BACKGROUND

It is known to use tools such as wrenches and sockets to fasten different types of fastener heads. However, over time a fastener may become worn, and the corners of the fastener may become rounded. This means that a socket or wrench may no longer be effective at fastening or loosening the fastener and even further round the corners of the fastener.

It is known to alter the profile of various wrenches, e.g. such as shown in U.S. Pat. No. 9,718,170. However, a problem with this arrangement is that the tool is most effective when the corners of the fastener are evenly worn.

### SUMMARY

Examples of the present disclosure aim to address the aforementioned problems.

According to an aspect of the present disclosure there is a tool for driving a fastener comprising a first fastener corner and a second fastener corner and a first fastener flat surface extending therebetween having a flat surface length; the tool comprising: a socket with a socket cavity having a first tool recess arranged to receive the first fastener corner and a second tool recess arranged to receive the second fastener corner and a first protruding portion between the first tool recess and the second tool recess; wherein the first protruding portion is arranged to engage the first fastener flat surface at a first protrusion engagement position between 34% to 41% of the flat surface length from the first fastener corner and the protrusion height of the first protruding portion is 2.8% of an opening dimension of the socket cavity.

Optionally the socket cavity has a third tool recess arranged to receive a third fastener corner and a fourth tool recess arranged to receive a fourth fastener corner and a second protruding portion between the third tool recess and the fourth tool recess.

Optionally the second protruding portion is arranged to engage a third fastener flat surface between the third fastener corner and fourth fastener corner at a second protrusion engagement position between 34% to 41% of the flat surface length from the third fastener corner and the protrusion height of the second protruding portion is 2.8% of an opening dimension of the socket cavity.

Optionally the socket cavity has a fifth tool recess arranged to receive a fifth fastener corner and a sixth tool recess arranged to receive a sixth fastener corner and a third protruding portion between the fifth tool recess and the sixth tool recess.

Optionally the third protruding portion is arranged to engage a fifth fastener flat surface between the fifth fastener corner and the sixth fastener corner at a third protrusion engagement position between 34% to 41% of the flat surface length from the fifth fastener corner and the protrusion height of the third protruding portion is 2.8% of an opening dimension of the socket cavity.

Optionally the socket cavity has a fourth protruding portion, a fifth protruding portion and a sixth protruding portion respectively between the second tool recess and the third tool recess, the fourth tool recess and the fifth tool recess, and the sixth tool recess and the first tool recess.

Optionally the fourth protruding portion, the fifth protruding portion and the sixth protruding portion are respectively arranged to engage a second fastener flat surface between the second fastener corner and the third fastener corner, a fourth fastener flat surface between the fourth fastener corner and the fifth fastener corner, and a sixth fastener flat surface between the sixth fastener corner and the first fastener corner.

Optionally each of the fourth protruding portion, the fifth protruding portion and the sixth protruding portion are respectively arranged to engage the second fastener flat surface, the fourth fastener flat surface, sixth fastener flat surface, at a protrusion engagement position between 34% to 41% of the flat surface length from the second fastener corner, fourth fastener corner and the sixth fastener corner and the protrusion height of the fourth protruding portion, the fifth protruding portion, and the sixth protruding portion are each 2.8% of an opening dimension of the socket cavity.

Optionally the first protruding portion is curved.

Optionally the socket cavity is arranged to engage the first fastener flat surface at a first flat engagement position between 75% to 82% of the flat surface length from the first fastener corner.

Optionally the socket cavity is arranged to engage the third fastener flat surface at a third flat engagement position between 75% to 82% of the flat surface length from the third fastener corner.

Optionally the socket cavity is arranged to engage the fifth fastener flat surface at a fifth flat engagement position between 75% to 82% of the flat surface length from the fifth fastener corner.

Optionally the tool is a nut driver, a socket driver or a wrench.

### BRIEF DESCRIPTION OF THE DRAWINGS

Various other aspects and further examples are also described in the following detailed description and in the attached claims with reference to the accompanying drawings, in which:

FIG. 1 shows a perspective view of the tool and a fastener according to some examples;

FIG. 2 shows a close-up cross-sectional view of the profile of one of the sides of the tool as shown in FIG. 3 according to some examples;

FIG. 3 shows a cross-sectional view of the tool according to some examples;

FIG. 4 shows another cross-sectional view of the tool together with the fastener according to some examples;

FIG. 5 shows a close-up cross-sectional view of the tool according to some examples as shown in FIG. 4;

FIG. 6 shows a plan view of the fastener; and

FIG. 7 shows a plan view of the fastener with rounded corners.

### DETAILED DESCRIPTION

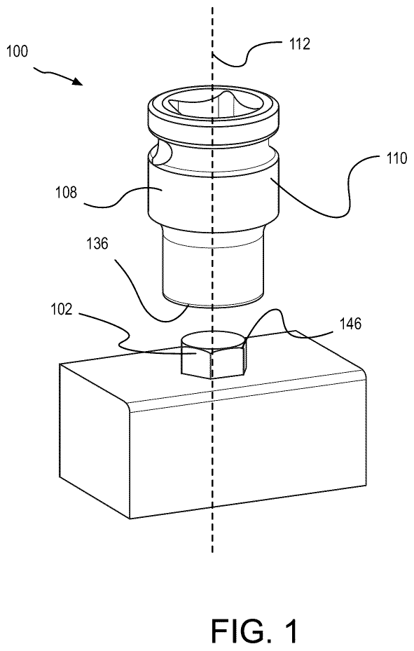

FIG. 1 shows a perspective view of a tool 100 together with a fastener 102. The fastener 102 is typically a hexagonal fastener 102, for example a bolt. However, in other examples, the fastener 102 may have a different shaped head, e.g. square, triangular, pentagonal etc.

The tool 100, as shown in FIG. 1, is a socket wrench. However, in other examples, the tool 100 can be any suitable tool for fastening or loosening a fastener 102, e.g. a hexagonal fastener 102, such as a wrench, etc. The tool 100, as shown in FIG. 1, comprises a tool body 110, which extends along a longitudinal axis 112. The tool 100 comprises a socket 108, having a socket cavity 136, with a specific cross-sectional geometry. The cross-sectional geometry will be discussed in more detail below.

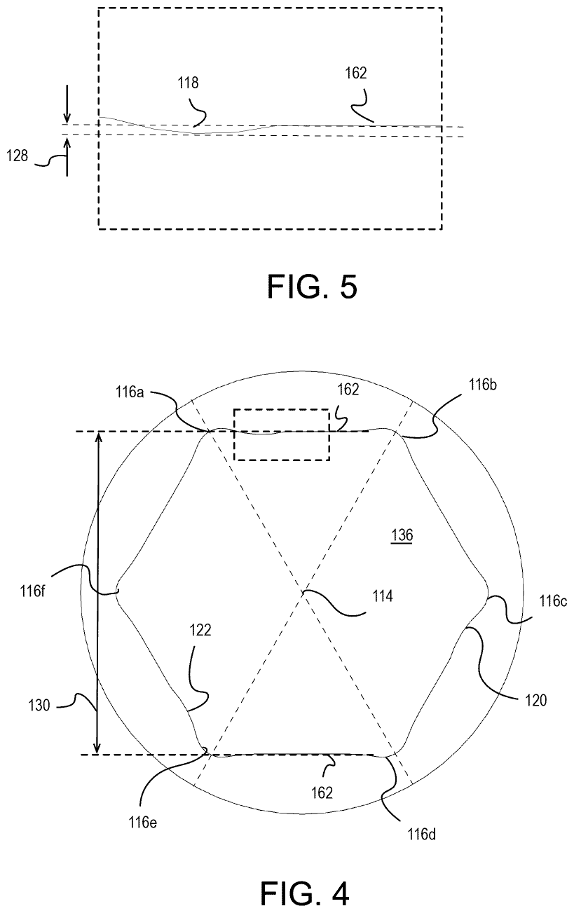

The longitudinal axis 112 of the tool 100 is aligned with a tool centre 114, which is best shown in e.g. FIG. 4. The tool centre 114 is a centre point of the tool 100, and in use the tool 100 rotates about the tool centre 114 and the longitudinal axis 112 when loosening or fastening the fastener 102.

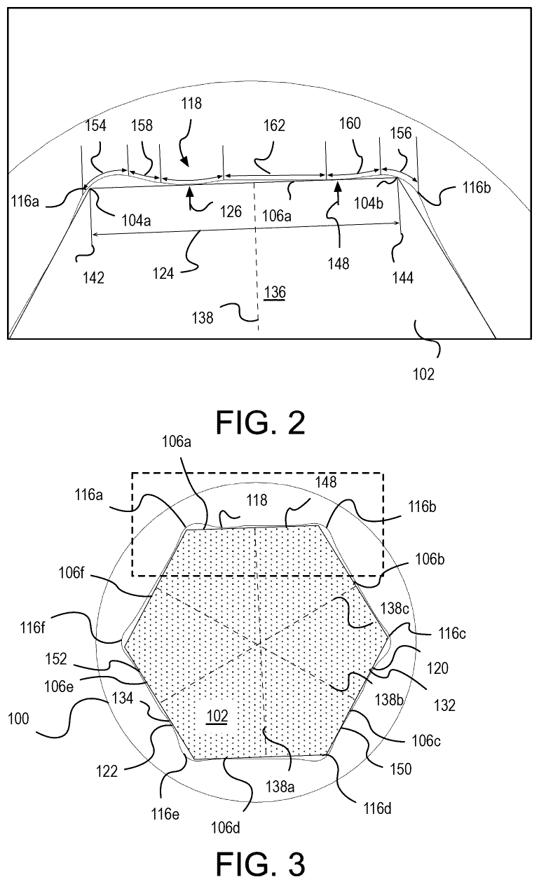

The profile and cross-sectional geometry of the tool 100 will now be discussed in more detail with respect to FIGS. 2 and 3. FIG. 2 shows a partial cross-sectional view of the tool 100. The socket cavity 136 comprises a plurality of tool recesses 116 for receiving a fastener corner 104.

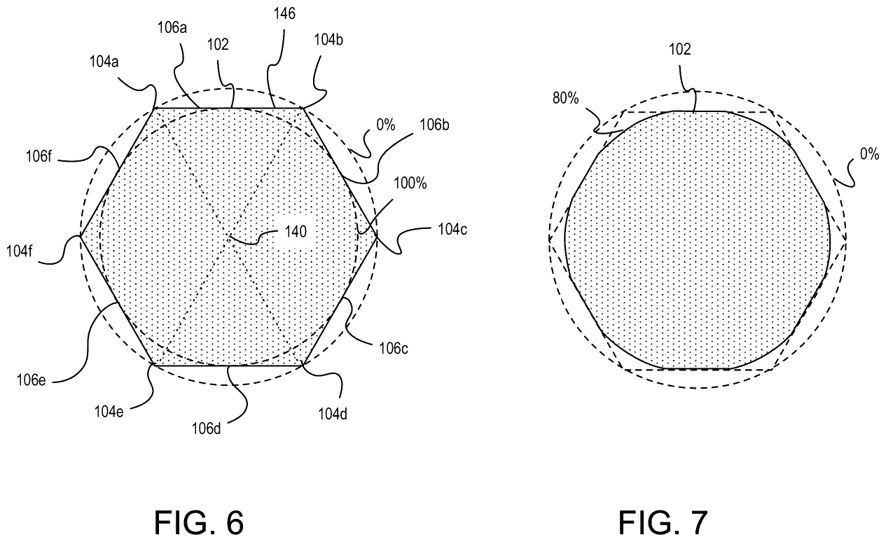

As can be seen from FIG. 2, the tool 100 comprises a first tool recess 116a and a second tool recess 116b. The first tool recess 116a and the second tool recess 116b are arranged to respectively receive a first fastener corner 104a and a second fastener corner 104b. Since the tool 100 is configured to tighten and loosen a fastener 102 with a hexagonal fastener head 146, the tool 100 comprises six tool recesses 116 respectively arranged to engage six fastener corners 104. The first fastener corner 104a is centred on a first centre point 142 as shown in FIG. 2. Similarly, the second tool recess 116b is centred on a second centre point 144. The first tool recess 116a and the second tool recess 116b are arranged to respectively receive the first fastener corner 104a and the second fastener corner 104b irrespective of the state of wear (e.g. the roundedness of the fastener corners 104, best shown in FIGS. 6 and 7 below) of the first fastener corner 104a and the second fastener corner 104b.

The first tool recess 116a and the second tool recess 116b are aligned along one side of the socket cavity 136, corresponding to a side of the fastener 102 when the fastener 102 is inserted into the tool 100. The tool 100 comprises a first protruding portion 118 between the first tool recess 116a and the second tool recess 116b.

As shown in FIG. 2, the first protruding portion 118 extends into the socket cavity 136. The first protruding portion 118 is arranged to engage a first fastener flat surface 106a. The first fastener flat surface 106a extends between the first fastener corner 104a and the second fastener corner 104b. The first protruding portion 118 advantageously engages the first fastener flat surface 106a and can impart a torque on the fastener head 146 in use. This means that if the fastener corners 104 of the fastener 102 are worn, the tool 100 is still able to impart a torque to the fastener 102. This means that the tool 100 can effectively grip the worn fastener 102, but also not engage the first fastener corner 104a and the second fastener corner 104b which prevents further rounding of the fastener corners 104 of the fastener 102.

Reference will now be briefly made to FIGS. 6 and 7. FIG. 6 shows a plan view of a fastener 102 and a fastener head 146. As shown in FIG. 6, the fastener 102 is not worn and comprises fully formed fastener corners 104.

In particular, the fastener 102 comprises a first fastener corner 104a, a second fastener corner 104b, a third fastener corner 104c, a fourth fastener corner 104d, a fifth fastener corner 104e and a sixth fastener corner 104f. In between the fastener corners 104 extend flat surfaces. In particular, a first fastener flat surface 106a extends between a first fastener corner 104a and a second fastener corner 104b. A second fastener flat surface 106b extends between the second fastener corner 104b and the third fastener corner 104c. A third fastener flat surface 106c extends between the third fastener corner 104c and a fourth fastener corner 104d. A fourth fastener flat surface 106d extends between the fourth fastener corner 104d and a fifth fastener corner 104e. A fifth fastener flat surface 106e extends between a fifth fastener corner 104e and a sixth fastener corner 104f. Finally, a sixth fastener flat surface 106f extends between the sixth fastener corner 104f and the first fastener corner 104a.

FIG. 6 also shows a nominal circle which indicates a zero percentage wear of the fastener 102 when there is no wear on the fastener 102. This represents a new fastener 102 without any wear. The tips of the unworn fastener corners 104 of the fastener 102 touch the zero percentage circle as shown in FIG. 6. When the fastener corners 104 of the fastener 102 are fully worn, then the fastener 102 forms a circle indicated by the 100% worn circle. In other words, the hexagonal shaped fastener 102 has worn down to the maximum size circle that fits within the hexagon as shown in FIG. 6. In between the two extremes of 100% worn and 0% worn, the fastener corners 104 of the fastener 102 can be partially worn. For example, as shown in FIG. 7, the fastener 102 comprises fastener corners 104 which are worn to 80%.

FIG. 6 also shows a fastener centre 140 of the fastener 102. The fastener centre 140 is the centre of the fastener 102 as defined by the intersection between diametrically opposite lines between opposite fastener corners 104. When there is no wear on the fastener 102, the fastener centre 140 will be concentric with the longitudinal axis 112 and the tool centre 114. However, when the fastener 102 experiences wear, then the fastener centre 140 will be offset from the tool centre 114 when the tool 100 is used to rotate the fastener 102 as discussed below.

As mentioned above, the tool 100 comprises a socket cavity 136 arranged to engage a hexagonal fastener 102. As shown in FIG. 4, the tool 100 comprises a first tool recess 116a, a second tool recess 116b, a third tool recess 116c, a fourth tool recess 116d, a fifth tool recess 116e and a sixth tool recess 116f.

The first tool recess 116a, the second tool recess 116b, the third tool recess 116c, the fourth tool recess 116d, the fifth tool recess 116e, the sixth tool recess 116f are arranged to respectively engage the first fastener corner 104a, the second fastener corner 104b, the third fastener corner 104c, the fourth fastener corner 104d, the fifth fastener corner 104e and the sixth fastener corner 104f.

Turning back to FIGS. 2 and 3, the profile of the first protruding portion 118 will now be discussed in more detail. The first protruding portion 118, as discussed above, extends into the socket cavity 136. FIG. 2 shows a centreline 138 of the tool 100 which is aligned with the tool centre 114. The tool 100 is arranged such that the first protruding portion 118 is offset from the centreline 138 which is a midpoint between the nominal line between the first centre point 142 of the first tool recess 116a to a second centre point 144 of the second tool recess 116b.

FIG. 4 shows further examples of centrelines 138a, 138b, 138c aligned with the tool centre 114. The centrelines 138a, 138b, 138c respectively corresponding to a midpoint between the nominal line between the first centre point 142 of the first tool recess 116a to a second centre point 144 of the second tool recess 116b, a midpoint between the nominal line between a first centre point 142 of the first tool recess 116a to a centre point of the sixth tool recess 116f, and a centre point of the third tool recess 116c to a second centre point 144 of the second tool recess 116b.

This means that the cross-sectional shape of the tool 100 e.g. the first protruding portion 118 causes the fastener 102 to move with respect to the tool 100 during use. This means that the flat surfaces e.g. the first fastener flat surface 106a engages the first protruding portion 118 during use. This means that the first tool recess 116a and the second tool recess 116b do not engage the corresponding first fastener corner 104a and second fastener corner 104b if the first fastener corner 104a and the second fastener corner 104b are worn. This is discussed in more detail below with respect to FIG. 2.

The profile of the socket cavity 136 will now be described with reference to FIGS. 2, 3, 4 and 5. FIG. 2 shows a close up cross sectional view of the tool 100. FIG. 3 shows a cross sectional view of the tool 100 together with the fastener 102. FIG. 4 shows another cross sectional view of the tool 100. FIG. 5 shows a close up cross sectional view of the tool 100 represented by the dotted box in FIG. 4.

As shown in FIG. 2, the tool 100 comprises a first protruding portion 118. However, as shown in FIG. 3, the tool 100 additionally comprises a second protruding portion 120 and a third protruding portion 122.

The socket cavity 136 therefore comprises a first protruding portion 118, a second protruding portion 120 and a third protruding portion 122. As shown in FIG. 4 and FIG. 3, the first protruding portion 118 is located between the first tool recess 116a and the second tool recess 116b. The second protruding portion 120 is located between the third tool recess 116c and the fourth tool recess 116d. The third protruding portion 122 is located between the fifth tool recess 116e and the sixth tool recess 116f. Accordingly, the first protruding portion 118, the second protruding portion 120 and the third protruding portion 122 are circumferentially spaced around the socket cavity 136.

The profile of the socket cavity 136 between the first tool recess 116a and the second tool recess 116b will now be described in more detail with reference to FIG. 2. The first tool recess 116a and the second tool recess 116b have rounded surfaces. Indeed, the first tool recess 116a comprises a first tool recess radius 154 and the second tool recess 116b comprises a second tool recess radius 156. The first tool recess radius 154 and the second tool recess radius 156 are curved such that the first fastener corner 104a and the second fastener corner 104b do not engage the surface of the first tool recess 116a and the second tool recess 116b. This means that the first fastener corner 104a and the second fastener corner 104b are not worn by the first tool recess 116a and the second tool recess 116b.

Extending from the first tool recess radius 154 is a first curve tool recess surface 158. The first curve tool recess surface 158 is adjacent to the first protruding portion 118. The radius of curvature of the first curve tool recess surface 158 is different from the radius of curvature of the first protruding portion 118. The first protruding portion 118 extends between the first curve tool recess surface 158 and a tool recess flat surface 162. The tool recess flat surface 162 is arranged to be slightly angled to the first fastener flat surface 106a when the fastener 102 is inserted into the socket cavity 136.

The tool recess flat surface 162 extends until a second curve tool recess surface 160. The second curve tool recess surface 160 has the same or a similar radius of curvature as the first curve tool recess surface 158. The second curve tool recess surface 160 extends to the second tool recess radius 156.

When the fastener 102 is inserted into the socket cavity 136, the first protruding portion 118 engages the first fastener flat surface 106a at a first protrusion engagement position 126. In this way, the first protruding portion 118 is arranged to engage a flat portion of the fastener 102. This means that the socket cavity 136 is able to engage and impart a torque to the fastener head 146 even if the fastener 102 is rounded, e.g. as shown in FIG. 7.

The profile of the socket cavity 136 between the first tool recess 116a and the second tool recess 116b is also arranged to engage the first fastener flat surface 106a at a first flat engagement position 148. In this way, the first fastener flat surface 106a is engaged at the first protrusion engagement position 126 by the first protruding portion 118 and at the first flat engagement position 148 by the tool recess flat surface 162.

The first protruding portion 118 and the first protrusion engagement position 126 is positioned between the first tool recess 116a and the second tool recess 116b at a position between 34% to 41% of a flat surface length 124 from the first fastener corner 104a. The flat surface length 124 is the distance between the first fastener corner 104a and the second fastener corner 104b when there is no wear on the fastener 102 e.g. as shown in FIG. 6.

Furthermore, the first flat engagement position 148 is positioned between the first tool recess 116a and the second tool recess 116b at a position between 75% to 82% of a flat surface length 124 from the first fastener corner 104a.

Advantageously, the first protruding portion 118 providing the first protrusion engagement position 126 at a position of 34-41% of a flat surface length 124 from the first fastener corner 104a imparts sufficient torque to loosen or tighten a fastener 102 whilst avoiding rounded fastener corners 104 of the fastener 102. Likewise, the position of the first flat engagement position 148 similarly aids this function. This is because the first protrusion engagement position 126 and the first flat engagement position 148 is offset from the centreline 138 and therefore the structure as shown in FIG. 2 strikes a balance between effectively engaging the socket cavity 136 with the fastener head 146 whilst avoiding the rounded fastener corners 104.

The first protruding portion 118 comprises a protrusion height 128 as shown in FIG. 5. In some examples the protrusion height 128 of the first protruding portion 118 extends 2.8% of an opening dimension 130 of the socket cavity 138. The opening dimension 130 is shown in FIG. 4 and is the distance between the tool recess flat surface 162 and the opposite tool recess flat surface 162. In other words, the opening dimension 130 of the socket cavity 136 is the maximum distance between opposing flat surfaces in the socket cavity 138. The first protruding portion 118 has a protrusion height 128 in terms of the distance the first protruding portion 118 extends into the socket cavity 136 from the tool recess flat surface 162 as shown in FIG. 5.

As described above, the socket cavity 136 also comprises a second protruding portion 120 and a third protruding portion 122, which also extend into the socket cavity 138. As shown in FIG. 4, the first protruding portion 118 is located between the first tool recess 116a and the second tool recess 116b. The second protruding portion 120 is located between the third tool recess 116c and the fourth tool recess 116d and the third protruding portion 122 is located between the fifth tool recess 116e and the sixth tool recess 116f.

The profile of the first protruding portion 118, the second protruding portion 120, and the third protruding portion 122 are the same. That is, the profile as discussed with reference to FIG. 2 between the first tool recess 116a and the second tool recess 116b is the same for the profile between the third tool recess 116c and the fourth tool recess 116d, and the profile between the fifth tool recess 116e and the sixth tool recess 116f.

As shown in FIG. 3, the second protruding portion 120 engages a third fastener flat surface 106c at a second protrusion engagement position 132. The same side of the socket cavity 136 also engages the third fastener flat surface 106c at a second flat engagement position 150, similar to the first flat engagement position 148 as previously discussed. Similarly, the third protruding portion 122 engages a fifth fastener flat surface 106e at a third protrusion engagement position 134. Likewise, the same side of the socket cavity 138 engages the fifth fastener flat surface 106e at a third flat engagement position 152. Accordingly, each of the first protruding portion 118, the second protruding portion 120, and the third protruding portion 122 engage the fastener 102 in the same way.

In an alternative example not shown in the accompanying figures, the socket cavity 136 further comprises a fourth protruding portion, a fifth protruding portion and a sixth protruding portion. In this way, the socket cavity 136 comprises a protruding portion on each of the sides of the socket cavity 136. The fourth protruding portion is located between the second tool recess 116b and the third tool recess 116c. The fifth protruding portion is located between the fourth tool recess 116d and the fifth tool recess 116e and the sixth protruding portion is located between the sixth tool recess 116f and the first tool recess 116a.

The fourth protruding portion, the fifth protruding portion and the sixth protruding portion comprise the same profile and dimensions as previously discussed with respect to the first protruding portion 118. Accordingly, the fourth protruding portion, the fifth protruding portion and the sixth protruding portion are respectively arranged to engage a second fastener flat surface 106b between the second fastener corner 104b and the third fastener corner 104c, a fourth fastener flat surface 106d between the fourth fastener corner 104d and the fifth fastener corner 104e and a sixth fastener flat surface 106f between the sixth fastener corner 104f and the first fastener corner 104a.

Each of the fourth protruding portion, the fifth protruding portion and the sixth protruding portion are respectively arranged to engage the second fastener flat surface 106b, the fourth fastener flat surface 106d, and the sixth fastener flat surface 106f, at a protrusion engagement position between 34% to 41% of the flat surface length 124 from the second fastener corner 104b, fourth fastener corner 104d and the sixth fastener corner 104f and the protrusion height 128 of the fourth protruding portion, the fifth protruding portion, and the sixth protruding portion are each 2.8% of an opening dimension 130 of the socket cavity 136.

Furthermore, each of the sides of the tool 100 having the fourth protruding portion, the fifth protruding portion and the sixth protruding portion also have a flat engagement position is respectively positioned between 75% to 82% of the flat surface length 124 from the second fastener corner 104b, fourth fastener corner 104d and the sixth fastener corner 104f. Accordingly, the profiles discussed are the same for each side of the tool 100.

This advantageously means that the tool 100 can tighten or loosen a fastener 102 with one or more rounded fastener corners 104 without engaging the rounded fastener corners 104. Furthermore, it does not matter if some or all of the fastener corners 104 of the fastener 102 are worn or if the fastener corners 104 are worn unevenly.

In another example, two or more examples are combined. Features of one example can be combined with features of other examples.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealised or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed:

1. A tool for driving a fastener comprising a first fastener corner and a second fastener corner and a first fastener flat surface extending therebetween having a flat surface length, the tool comprising:
a socket with a socket cavity having a first tool recess arranged to receive the first fastener corner and a second tool recess arranged to receive the second fastener corner and a first protruding portion between the first tool recess and the second tool recess;
wherein the first protruding portion is arranged to engage the first fastener flat surface at a first protrusion engagement position between 34% to 41% of the flat surface length from the first fastener corner and the protrusion height of the first protruding portion is 2.8% of an opening dimension of the socket cavity.

2. The tool according to claim 1 wherein the socket cavity has a third tool recess arranged to receive a third fastener corner and a fourth tool recess arranged to receive a fourth fastener corner and a second protruding portion between the third tool recess and the fourth tool recess.

3. The tool according to claim 2 wherein the second protruding portion is arranged to engage a third fastener flat surface between the third fastener corner and fourth fastener corner at a second protrusion engagement position between 34% to 41% of the flat surface length from the third fastener corner and the protrusion height of the second protruding portion is 2.8% of an opening dimension of the socket cavity.

4. The tool according to claim 3 wherein the socket cavity has a fifth tool recess arranged to receive a fifth fastener corner and a sixth tool recess arranged to receive a sixth fastener corner and a third protruding portion between the fifth tool recess and the sixth tool recess.

5. The tool according to claim 4 wherein the third protruding portion is arranged to engage a fifth fastener flat surface between the fifth fastener corner and the sixth fastener corner at a third protrusion engagement position between 34% to 41% of the flat surface length from the fifth fastener corner and the protrusion height of the third protruding portion is 2.8% of an opening dimension of the socket cavity.

6. The tool according to claim 5 wherein the socket cavity has a fourth protruding portion, a fifth protruding portion and a sixth protruding portion respectively between the second tool recess and the third tool recess, the fourth tool recess and the fifth tool recess, and the sixth tool recess and the first tool recess.

7. The tool according to claim 6 wherein the fourth protruding portion, the fifth protruding portion and the sixth protruding portion are respectively arranged to engage a second fastener flat surface between the second fastener corner and the third fastener corner, a fourth fastener flat surface between the fourth fastener corner and the fifth fastener corner, and a sixth fastener flat surface between the sixth fastener corner and the first fastener corner.

8. The tool according to claim 7 wherein each of the fourth protruding portion, the fifth protruding portion and the sixth protruding portion are respectively arranged to engage the second fastener flat surface, the fourth fastener flat surface, sixth fastener flat surface, at a protrusion engagement position between 34% to 41% of the flat surface length from the second fastener corner, fourth fastener corner and the sixth fastener corner and the protrusion height of the fourth protruding portion, the fifth protruding portion, and the sixth protruding portion are each 2.8% of an opening dimension of the socket cavity.

9. The tool according to claim 1 wherein the first protruding portion is curved.

10. The tool according to claim 1 wherein the socket cavity is arranged to engage the first fastener flat surface at a first flat engagement position between 75% to 82% of the flat surface length from the first fastener corner.

11. The tool according to claim 3 wherein the socket cavity is arranged to engage the third fastener flat surface at a third flat engagement position between 75% to 82% of the flat surface length from the third fastener corner.

12. The tool according to claim 5 wherein the socket cavity is arranged to engage the fifth fastener flat surface at a fifth flat engagement position between 75% to 82% of the flat surface length from the fifth fastener corner.

13. The tool according to claim 1 wherein the tool is a nut driver, a socket driver or a wrench.
